(19) United States
(12) Patent Application Publication
(10) Pub. No.: US 2026/0007184 A1
(43) Pub. Date: Jan. 8, 2026

(54) An Aerosol Generating Device

(71) Applicant: JT International SA, Geneva (CH)

(72) Inventor: Alec Wright, Guildford (GB)

(73) Assignee: JT International SA, Geneva (CH)

(21) Appl. No.: 18/846,826

(22) PCT Filed: Mar. 15, 2023
(86) PCT No.: PCT/EP2023/056589

§ 371 Date: Sep. 13, 2024

(30) Foreign Application Priority Data
Mar. 17, 2022 (EP) 22162694.8

(51) Int. Cl. A24F 40/57; A24F 7/00; A24F 40/20; A24F 40/46; A24F 40/51; H05B 1/02

(52) U.S. Cl. CPC A24F 40/57; A24F 7/00; A24F 40/20; A24F 40/46; A24F 40/51; H05B 1/0244

(57) ABSTRACT

An aerosol generating device receives an aerosol substrate and provides electric power to the aerosol substrate. The aerosol generating device includes at least two electrodes configured to electrically couple with the aerosol substrate to provide electric power to the aerosol substrate, in use; a proximity sensor configured to sense proximity of a user in a first direction; and a control unit configured to: compare the sensed proximity with a predetermined threshold; and increase the electric power provided to the aerosol substrate to an inhalation electric power when the sensed proximity is less than the predetermined threshold. There is also provided a method of operating an aerosol generating device.

### TECHNICAL FIELD

The present disclosure relates to an aerosol generating device, such as a heat-not-burn device. The present disclosure also relates to a method of operating an aerosol generating device.

### BACKGROUND

Various devices and systems are available that heat aerosol substrates to release aerosol/vapour for inhalation, rather than relying on burning the aerosol substrate. For example, e-cigarettes vaporize an e-liquid to an inhalable vapour. However, e-cigarettes are vulnerable to leakage of the e-liquid but benefit from fast volatilisation times. Alternative devices with solid consumables are available. However, such devices require a heater to be part of the device and hence the device requires adequate insulation to prevent a user from being exposed to the high heater temperatures, which leads to additional complexity and cost in the device.

A challenge associated with heating aerosol substrate rather than burning it is that there is an increased time to generate the aerosol from the aerosol substrate. A further challenge is that once the aerosol substrate is heated to the volatilisation temperature, aerosol may be continuously generated even when a user is not inhaling, thereby wasting energy and the aerosol substrate.

It is the object of the invention to overcome at least one of the above referenced problems, or to provide an alternative solution.

### SUMMARY

According to the present disclosure there is provided an aerosol generating device and a method of operating an aerosol generating device including the features as set out in the claims.

According to one aspect, there is provided an aerosol generating device for receiving an aerosol substrate and providing electric power to said aerosol substrate, the aerosol generating device comprising: at least two electrodes configured to electrically couple with said aerosol substrate to provide electric power to said aerosol substrate, in use; a proximity sensor configured to sense proximity of a user in a first direction (A); and a control unit configured to: compare the sensed proximity with a predetermined threshold; and increase the electric power provided to said aerosol substrate to an inhalation electric power when the sensed proximity is less than the predetermined threshold.

Utilising the proximity sensor with the aerosol generating device significantly reduces the waiting time for a user before obtaining a satisfying inhalation in terms of aerosol volume and flavour delivery from the aerosol generating substrate. Aerosol generating material in the device will be heated to appropriate aerosol generating temperature when a user is within the predetermined threshold of the proximity sensor. This is particularly advantageous in this device in which electrical power itself is applied to the aerosol substrate and the aerosol substrate is heated internally. Heating times of the aerosol substrate may be reduced to a few seconds only, which results in an improved user experience by catering for “puff on demand”. In contrast with traditional heat-not-burn aerosol generating devices which require a wait time of approximately 20 s, using this aerosol generating device may reduce wait times to less that 4 s. Providing the inhalation electric power means that the aerosol substrate is heated to an inhalation temperature in which sufficient aerosol is generated for a user to perform an inhalation action.

In one example, the aerosol generating device is configured to be activated in response to a user's action and the aerosol generating device is configured to provide a priming electric power to said aerosol substrate in response to the user's action, wherein the priming electric power is less than the inhalation electric power. Providing the priming electric power means that the aerosol substrate is heated to an “intermediate” priming temperature in which a negligible amount of aerosol is generated. This reduces the time taken to increase the temperature to the inhalation temperature in which a substantial amount of aerosol is generated for a user inhalation.

The user's action may be a button press, swipe on a touch pad, insertion of an aerosol generating substrate in the aerosol generating device and/or an inhalation action on the aerosol generating device.

The aerosol generating device may include a puff sensor configured to detect an inhalation action on the aerosol generating device by the user, wherein the user's action is the inhalation action.

The aerosol generating device may include a puff sensor configured to detect an inhalation action on the aerosol generating device by the user, wherein the control unit is configured to increase the provided electric power from the inhalation electric power to a boost electric power in response to an inhalation action being detected by the puff sensor.

The provision of an aerosol generating device that is configured to provide various levels of electric power to the aerosol substrate means that the energy use within the aerosol generating device can be carefully controlled so that unnecessary energy is not used during an inhalation session. Further, the aerosol substrate is not “spoiled” by heating it unnecessarily when a user is not inhaling or within a predetermined threshold.

The aerosol generating device may be configured to provide a power of between 15 W to 25 W when an inhalation action is detected.

The puff sensor may be configured to detect an end of an inhalation action on the aerosol generating device by the user, wherein the control unit is configured to reduce the provided electric power from the boost electric power to the inhalation electric power when the end of the inhalation action is detected by the puff sensor. The provision of a boost electric power that coincides with a user drawing on the aerosol generating device results in an increased temperature in the aerosol substrate at a time when the user is inhaling the generated aerosol. The increased temperature results in a boost in the amount of aerosol generated to coincide with the user drawing on the aerosol generating device.

Reducing the electric power upon the detection of the end of the inhalation action means that energy (and the aerosol substrate) may be conserved and last for a longer duration.

In one example, the provided power is increased to the inhalation electric power as a step change when the sensed proximity is less than the predetermined threshold.

In one example, the provided power is increased to the inhalation electric power as a gradual change as a function of the sensed proximity.

In one example, the aerosol generating device includes one or more temperature sensors configured to directly or indirectly measure the temperature of said aerosol substrate. The proximity sensor may be activated when the one or more temperature sensors detects a priming temperature above a first temperature threshold. In one example, the first temperature threshold is between 50° C. to 100° C.

That is to say that the energy in the device is further preserved as the proximity sensor is only operational when it is of value to do so.

In one example, the control unit is configured to reduce the provided electric power from the inhalation electric power to the priming electric power if the determined distance increases above the predetermined threshold.

Reducing the inhalation electric power to the priming electric power means that the resultant temperature of the aerosol substrate is reduced, and so unnecessary aerosol is not generated when a user is not inhaling it.

In one example, the priming electric power is configured to heat the aerosol substrate to a priming temperature of between 0° C. and 125° C. and the inhalation electric power is configured to heat the aerosol substrate to an inhalation temperature of between 230° C. and 280° C.

In one example, the aerosol generating device comprises a mouthpiece, wherein the proximity sensor is arranged adjacent to the mouthpiece, and the first direction (A) extends along a longitudinal axis defined by the mouthpiece.

In one example, the aerosol generating device comprises a mouthpiece comprising a planar portion, wherein the proximity sensor is arranged on the planar portion of the mouthpiece and the first direction (A) extends in a direction substantially perpendicular to the planar portion.

In one example, the aerosol generating device includes an image sensor configured to detect a mouth of the user, wherein the first direction (A) extends between the proximity sensor and the mouth of the user, in use. Detecting a mouth of a user and setting the first direction such that is extends between the proximity sensor and the mouth of the user means improves the accuracy of the device.

According to one aspect, there is provided an aerosol generating system comprising: the aerosol generating device as defined in an aspect of the invention; and an aerosol substrate having one or more electrical conductors provided therein, wherein the at least two electrodes are configured to electrically couple with the one or more electrical conductors in the aerosol substrate. The aerosol substrate includes a solid aerosol precursor material and the one or more electrical conductors.

According to one aspect, there is provided a method of operating an aerosol generating device comprising: sensing, at a proximity sensor, a proximity to a user in a first direction (A); comparing the sensed proximity with a predetermined threshold; determining that the sensed proximity is less than the predetermined threshold; and increasing an electric power provided to at least two electrodes of the aerosol generating device to an inhalation electric power wherein the at least two electrodes are configured to electrically couple with an aerosol substrate having one or more electrical conductors therein.

Further advantages, objectives and features of the present invention will be described, by way of example only, in the following description with reference to the figures. In the figures, like components in different embodiments can exhibit the same reference symbols.

### BRIEF DESCRIPTION OF THE DRAWINGS

FIG. 1 is a schematic view of an aerosol generating device;

FIG. 2 is a schematic view of an aerosol substrate between two electrodes;

FIG. 3A is a schematic view of a user and the proximity sensor at a first distance, D1;

FIG. 3B is a schematic view of the user and the proximity sensor at a second distance, D2;

FIG. 4A is a first graph of a variation in electric power supplied to the electrodes;

FIG. 4B is a second graph of a variation in electric power supplied to the electrodes;

FIG. 4C is a third graph of a variation in electric power supplied to the electrodes; and

FIG. 5 is a flow chart of a method of operating the aerosol generating device;

Examples of the present disclosure will now be described with reference to the accompanying drawings.

### DETAILED DESCRIPTION

As used herein, the term aerosol substrate is a label used to mean a medium that generates an aerosol or vapour when heated. In one example, aerosol substrate is synonymous with smokable material, aerosol generating substrate and aerosol generating medium. Aerosol substrate includes materials that provide volatilized components upon heating, typically in the form of vapor or an aerosol. Aerosol substrate may be a non-tobacco-containing material or a tobacco-containing material. Aerosol substrate may, for example, include one or more of tobacco per se, tobacco derivatives, expanded tobacco, reconstituted tobacco, tobacco extract, homogenized tobacco or tobacco substitutes. Aerosol substrate also may include other, non-tobacco, products, which, depending on the product, may or may not contain nicotine. Aerosol substrate may comprise one or more humectants, such as glycerol or propylene glycol.

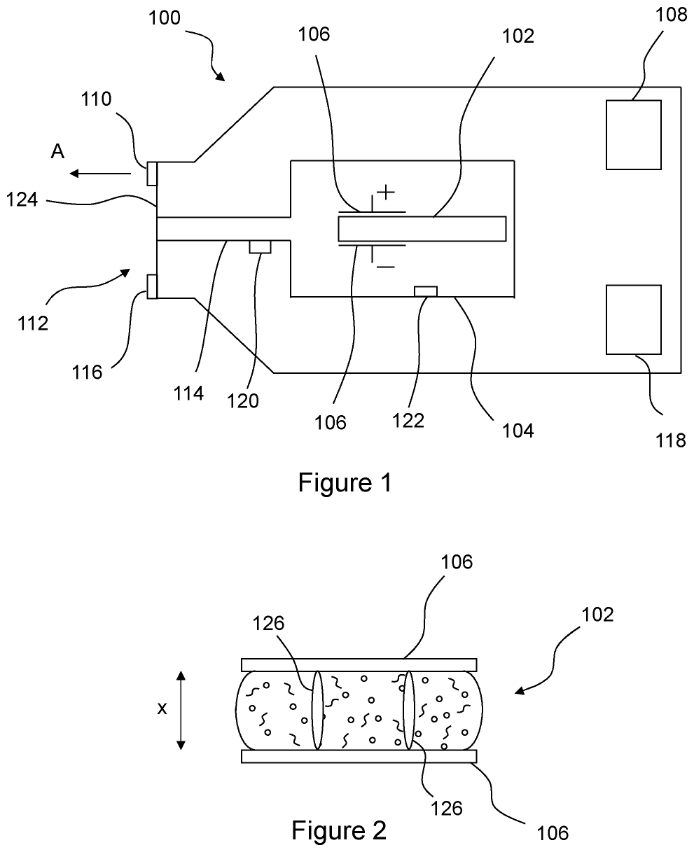

FIG. 1 shows a schematic cross-sectional view of an aerosol generating device 100. The aerosol generating device 100 is suitable for receiving an aerosol substrate 102 therein. For example, the aerosol generating device 100 may include a chamber 104 in which the aerosol substrate 102 is received.

The aerosol generating device 100 includes at least two electrodes 106 configured to provide an electric power to the aerosol substrate 102, in use. In one example, the at least two electrodes 106 are integral with an internal wall of the chamber 104. In other examples, the at least two electrodes 106 extend into the chamber 104. The at least two electrodes 106 are configured to be in direct contact with the aerosol substrate 102, in use. Preferably the aerosol substrate 102 is pressed between the at least two electrodes 106.

The aerosol generating device 100 includes a proximity sensor 110. The proximity sensor 110 is configured to sense the proximity of a user (or object) in a first direction.

In other words, the proximity sensor 110 monitors a distance from the aerosol generating device 100 to a user along the first direction A. The distance may be measured directly or indirectly using the proximity sensor 110. That is to say that the proximity sensor 110 may sense an actual distance to a user or alternatively generate a signal that is merely indicative of a distance to a user. In one example, the proximity sensor 110 is configured to distinguish between an object and a user.

The first direction A may be substantially aligned with a longitudinal axis of the aerosol generating device 100. In one example, the proximity sensor 110 comprises an infrared photoelectric sensor.

The aerosol generating device 100 may include a mouthpiece 112 through which a user draws on the aerosol generating device 100 to inhale generated aerosol. The mouthpiece 112 includes a vent or channel 114 that is connected to a region close to the aerosol substrate 102 for passage of any generated aerosol from the aerosol substrate 102, during use. For example, the channel 114 may extend between an opening in the mouthpiece 112 and the chamber 104 in which the aerosol substrate 102 is receivable. The mouthpiece 112 is arranged such it may be received in a user's mouth in use.

In one example, the mouthpiece 112 is arranged to have a substantially planar portion on which the proximity sensor 110 is located. In this example, the first direction A is arranged to be substantially perpendicular to the planar portion of the mouthpiece 112.

The aerosol generating device 100 may include a housing. In one example, the proximity sensor 110 may be arranged at a substantially planar portion of a wall of the aerosol generating device housing from which the mouthpiece extends or is releasably attached to. In this example, the first direction A is arranged then to be substantially perpendicular to the planar portion of the housing wall receiving the mouthpiece 112.

The aerosol generating device 100 also includes a control unit 108 (or control circuitry) for electronic management of the device. The control unit 108 may include a PCB or the like (not shown). The control unit 108 is configured to control the electrodes 106 and hence the amount of electric power provided to the aerosol substrate 102, for example by controlling the amount of electric power provided to the electrodes 106. In other words, each of the two electrodes 106 are arranged to provide (e.g. different) electrode potentials, in order to control the amount of electric power provided to the aerosol substrate 102. One electrode potential could be zero, or ground. The control unit 108 is configured to receive data from various sensors/inputs (such as the proximity sensor 110) and control the operation of the aerosol generating device 100 based on the received data.

The control unit 108 may be configured to receive the sensed data from the proximity sensor 110, in use. This sensed data may take the form of a measured distance of a user from the proximity sensor 110 in the first direction A. Alternatively, it may take the form of data indicative of a distance of a user from the proximity sensor 110 in the first direction A. The control unit 108 is configured to compare the sensed proximity data with a predetermined threshold. The predetermined threshold is indicative of a threshold distance between a user and the proximity sensor 110 in the first direction A. The control unit 108 is configured to control the electric power to the electrodes 106 based on the sensed proximity. If the control unit 108 determines that the sensed proximity is less than the predetermined threshold, then the control unit 108 is configured to control the electrodes 106 to provide an inhalation electric power to the aerosol substrate 102, as will be discussed in more detail below.

In one example, the predetermined threshold is indicative of a distance of 10 mm to 500 mm, more preferably 100 mm to 300 mm.

The aerosol generating device 100 may also include an image sensor 116, such as a charge-coupled device (CCD), active-pixel sensor (CMOS sensor) and/or camera. The image sensor 116 is configured to detect a user's mouth, in use. The image sensor 116 and/or control unit 108 may include software to determine if a user's mouth is present in the image taken by the image sensor 116.

If a user's mouth is detected by the image sensor, the first direction A is configured to be the direction from the proximity sensor 110 to the user's mouth. In this case, the proximity sensor 110 is configured to sense the proximity to the user's mouth.

The proximity sensor 110 and the image sensor 116 may be integral with each other. That is to say that in one example a single sensor performs the function of the proximity sensor 110 and the image sensor 116. In other examples, the proximity sensor 110 and the image sensor 116 are separate from each other.

As previously described in relation to the proximity sensor 110, the image sensor 116 may be located on or in a substantially planar surface of a wall of the housing of the aerosol generating device from which the mouthpiece 112 extends or is releasably attached to.

In one example, the aerosol generating device 100 includes an activation input sensor 118. The activation input sensor 118 may be a button, a touchpad, or the like for sensing a user's input such as a tap or swipe. In other examples, the activation input sensor 118 comprises an aerosol substrate sensor configured to detect if an aerosol substrate 102 has been inserted into the aerosol generating device 100. For example, the input sensor 118 may comprise an authenticity detector that is configured to detect if an aerosol substrate 102 comprising one or more electrical conductors 126 has been inserted into the aerosol generating device 100. The input sensor 118 may detect if the circuit between the at least two electrodes 106 is completed due to the presence of the aerosol substrate 102 comprising one or more electrical conductors 126.

As will be described below, the user input may also comprise an inhalation action by a user.

In one example, the aerosol generating device 100 includes a puff sensor 120 (otherwise known as an inhalation sensor). The puff sensor is configured to detect an inhalation action (or puff) by a user on the aerosol generating device 100. In one example, the puff sensor 120 comprises a microphone or a flow sensor configured to an airflow within the chamber 104 and/or an airflow channel extending from the chamber 104 through the mouthpiece 112 to an inhalation outlet thereof, the airflow being associated with a user's inhalation action. In other examples, the puff sensor 120 is configured to detect a change in pressure indicative of a beginning of an inhalation action on the aerosol generating device by the user. In this case, the puff sensor 120 may be located anywhere on the aerosol device 100 in which there would be a change in pressure due to an inhalation action of the user. In one example, the puff sensor is located in the channel 114 between the chamber 104 and the mouthpiece 112 of the aerosol generating device 100. The puff sensor 120 may also detect the end of an inhalation action by the user. For example, the puff sensor 120 may be configured to detect a further change in pressure due to the end of an inhalation action of a user.

In one example, the aerosol generating device 100 includes one or more temperature sensors 122 configured to directly or indirectly measure the temperature of said aerosol substrate 102 in the aerosol generating device 100. The one or more sensors may comprise a temperature sensor, such as a thermocouple or thermistor, configured to be located within or adjacent to the aerosol substrate 102 when it is received in the aerosol generating device 100. For example, the one or more temperature sensors 122 may be located within the chamber 104 of the aerosol generating device 100. In other examples, the temperature of the aerosol substrate 102 may be indirectly measured by the use of thermal imaging sensors.

The aerosol generating device 100 may include a power supply (not shown) such as a battery. The power supply may provide the aerosol generating device 100 with electrical energy providing a voltage in range of 1 V and 8 V. In a preferred embodiment the voltage source is a lithium-ion battery delivering a value of 3.7 V. Such a voltage source is particularly advantageous for a modern aerosol generating device in view of rechargeability.

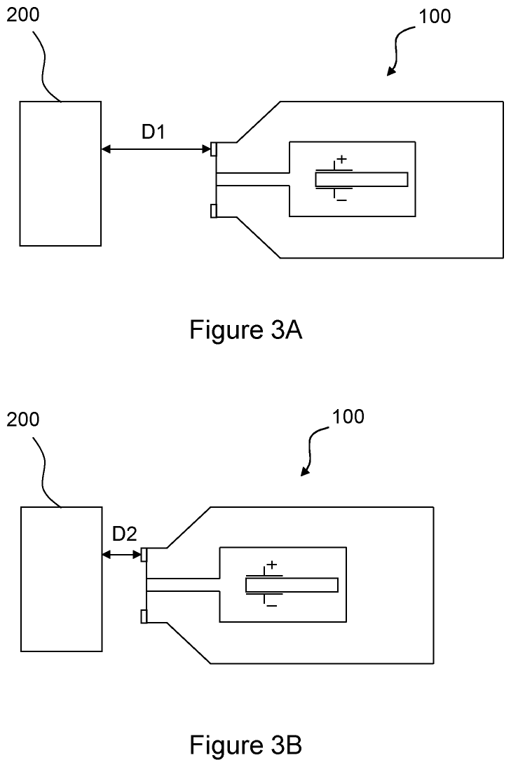

FIG. 2 is a schematic view of an aerosol substrate 102 between two electrodes 106. The aerosol substrate 102 comprises one or more electrical conductors 126 and a substance (such as solid aerosol precursor material) that may be heated to generate an aerosol. The one or more electrical conductors 126 are configured to conduct electricity received from the electrodes 106. The size and arrangement of the one or more electrical conductors 126 is set such that as an electrical electric power is passed through them, the temperature of the electrical conductors 126 increases to heat the aerosol substrate 102. The one or more electrical conductors 126 may be present in a particulate form throughout the aerosol substrate 102.

In one example, the at least two electrodes 106 include a first electrode and a second electrode that are spaced apart from each other by a distance x. In other examples, the at least two electrodes 106 includes a first set of electrodes and a second set of electrodes. The first set of electrodes are space apart from the second set of electrodes by distance x. Preferably the distance x is substantially similar to a thickness of the aerosol substrate 102.

The aerosol substrate 102 may comprise one or more dedicated heating layers, which are regions in which there is a high level of electrical conductors 126, or a relatively higher level of conduction due to the nature or number of electrical conductors 126. In other examples, electrical conductors 126 are distributed throughout the aerosol substrate 102. In one example, the aerosol substrate 102 is coated in one or more electrical conductors 126. The electrical conductors 126 may take the form of graphite or charcoal particles. The material may take the form of powder, loose or agglomerated particles. It is also conceivable to use other conductive materials which are approved in particular at least in the tobacco industry or food industry. The aerosol substrate 102 is configured to electrically connect the two electrodes 106 that it is located between. In this case, providing electric power to the at least two electrodes 106 is used interchangeably with providing electrical power to the aerosol substrate 102. As clear from the above, the aerosol substrate 102 may comprise a solid aerosol precursor material. That is the solid aerosol precursor material is not configured to flow in an unheated state. The solid aerosol precursor material is configured to generate aerosol upon the application of heat. The one or more electrical conductors may be located at least partially within the solid aerosol precursor material. For example, the aerosol substrate 102 comprises a solid aerosol precursor material and the one or more electrical conductors 126 within the solid aerosol precursor material. The one or more electrical conductors 126 may comprise a plurality of discrete electrical conductors distributed throughout the solid aerosol precursor material. In one example, the one or more electrical conductors 126 are in a particular form in the solid aerosol precursor material. In some examples, the one or more electrical conductors 126 are formed in regions within the aerosol precursor material. For example, the one or more electrical conductors 126 may be formed in layers in the solid aerosol precursor material. When the aerosol substrate 102 comprising the solid aerosol precursor material and the one or more conductors is placed between the one or more electrodes, electric power flows through the aerosol substrate and aerosol is generated. Providing one or more electrical conductors within a solid aerosol precursor material significantly reduces the time taken for aerosol to be generated for a user, in use.

In one example, the aerosol generating device 100 comprises an ohmmeter (or equivalent) configured to directly or indirectly measure the resistance of the aerosol substrate 102 between the electrodes 106. Based on the measured resistance data, the control unit 106 can then provide a set electric power to the aerosol substrate 102.

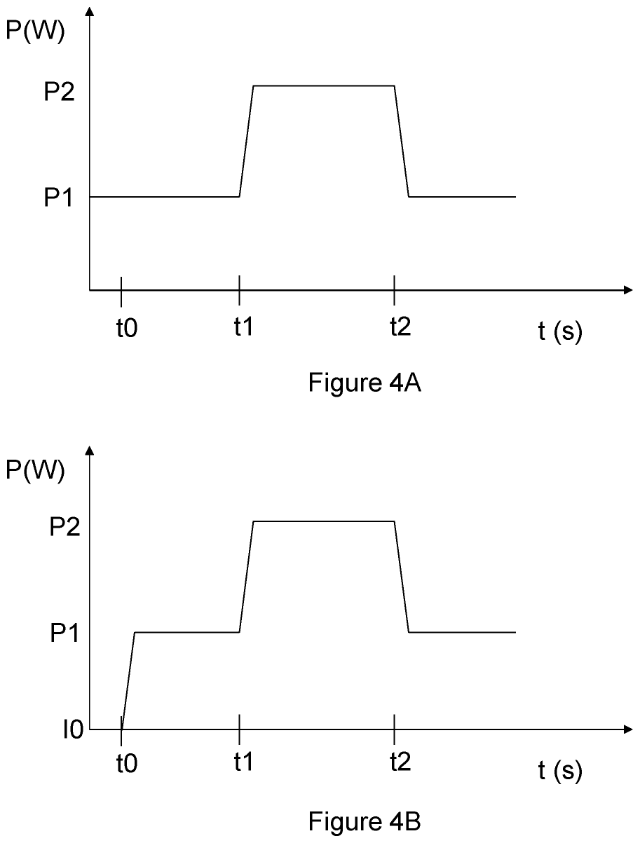

FIG. 3A shows an example of the aerosol generating device 100 spaced apart from a user 200 in a first direction by a first distance D1. In this example, the distance D1 is above the predetermined threshold and so the control unit 108 does not provide the inhalation electric power to the electrodes 106.

FIG. 3B shows an example of the aerosol generating device 100 spaced apart from the user 200 in the first direction by a second distance D2. In this example, the second distance D2 is less than the predetermined threshold. As such, the control unit 108 will control the electrodes 106 to increase the provides power to an inhalation electric power to the aerosol substrate 102, in use.

As the distance is sensed in a first direction, a user's hand that may be in permanent contact with the aerosol generating device 100 is not sensed. That is to say that the proximity sensor 110 is configured to sense a part of a user that is not in constant contact with the aerosol generating device 100 throughout an inhalation sensor, but rather sense a part of a user that may be initially distant.

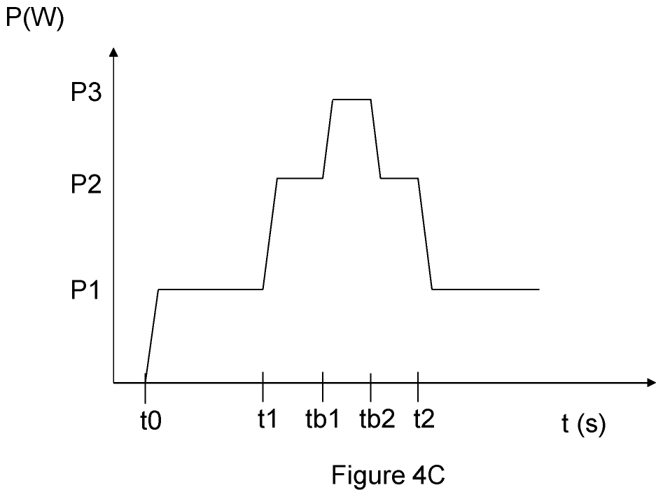

An example of the variation in electric power provided as the aerosol generating device 100 is moved closer to and further from the user 200 is shown in FIG. 4A. In this example, at t0, the user 200 is spaced from the proximity sensor 110 by a distance greater than the predetermined threshold. For example, the user may be spaced apart from the proximity sensor 110 by distance D1, as shown in FIG. 3A. In one example, there is no electric power supplied to the electrodes 106 at this time and P1 in FIG. 4A is equal to 0. In other examples, as will be described below, there is a priming electric power supplied to the electrodes 106 at this time.

At time t1, the distance (in the first direction, A) between the proximity sensor 110 and the user 200 has been reduced such that it is less than the predetermined threshold. At time t1, the control unit 108 increases the electric power provided to the electrodes 106 to the inhalation electric power, shown as P2 in FIG. 4A. The electric power may be increased to the inhalation electric power as a step change or at a gradient. That is to say that in some examples, the provided electric power is increased instantaneously (or substantially instantaneously) to the inhalation electric power when the sensed proximity is less than the predetermined threshold. In other examples, the provided electric power is increased gradually to the inhalation electric power. In one example, the provided electric power may have an inverse proportional relationship with the proximity such that it increases as the proximity decreases and reaches the inhalation electric power when the sensed proximity is less than the predetermined threshold.

In some examples, the electric power is configured to be maintained at the inhalation electric power for the duration of time that the distance between the proximity sensor 110 and the user 200 is less than the predetermined threshold. For example, as shown in FIG. 4A, the user and the proximity sensor 110 would be within a predetermined range between time t1 to time t2. At time t2, the user moves to a distance over the predetermined threshold away from the proximity sensor 110 in the first direction and the control unit 108 reduces the electric power provided to the electrodes 106.

In another example, the electric power is configured to be maintained at the inhalation electric power P2 for a predetermined period of time upon detection that the user is within the predetermined threshold from the proximity sensor 110 in the first direction A. In other words, in FIG. 4A, the time at which the electric power is set to the inhalation electric power is a predetermined time from t1.

The electric power may be reduced from the inhalation electric power as a step change or at a gradient. That is to say that in some examples, the provided electric power is decreased instantaneously (or substantially instantaneously) from the inhalation electric power when the sensed proximity is greater than the predetermined threshold. In other examples, the provided electric power is decreased gradually from the inhalation electric power. For example, the provided electric power may have an inverse proportional relationship with the proximity such that it decreases as the proximity increases.

The provision of electric power to the aerosol substrate 102 results in an increase in temperature in the one or more electrical conductors 126 of the aerosol substrate 102. The generated temperature within the aerosol substrate 102 is dependent upon the level of electric power provided. As such, a temperature profile of the aerosol substrate 102 would be substantially similar to the electric power profile, albeit the temperature profile may have a delay when compared with the electric power profile.

FIG. 4B shows a graph of a second example of the variation in provided electric power with time. In this example at time to, the electric power is increased to a priming electric power P1 in response to a user action. The user action may be an input on the activation input sensor 118, such as a button press or a user swipe. Alternatively, the user action may be the insertion of the aerosol substrate 102 within the aerosol generating device 100. The priming electric power is effectively an initial electric power to provide a first level of electric power to the aerosol substrate 102, which is less than the inhalation electric power P2. At the priming electric power P1, a relatively small level of aerosol is generated, as the temperature generated within the aerosol substrate 102 is relatively low, but the time taken to generate aerosol when the electric power is increased to the inhalation electric power is significantly reduced.

FIG. 4C shows a graph of a third example of the variation in electric power provided with time. The graph in FIG. 4C is similar to the example shown in FIG. 4B except that the electric power is increased to a boost electric power P3 at time tb1. Time tb1 corresponds to a time at which the puff detector 120 detects that a user 200 is inhaling from the aerosol generating device 100. In other words, at time tb1, the user is taking a puff on the aerosol generating device 100. In response to a puff being detected, the control unit 110 increases the electric power to the electrodes 106 to a boost electric power P3. In one example, the control unit 110 increase the electric power to a boost electric power P3 for a predetermined period of time. In other examples, the electric power is maintained at the boost electric power P3 until the puff sensor 120 detects that the user has stopped taking a puff on the aerosol generating device 100. Either of these events corresponds to time tb2 in FIG. 4C.

Whilst the increase to a boost electric power P3 is shown in combination with an embodiment in which the electric power is increased to the priming electric power P1 upon the detection of a user input, the boost electric power may be used with embodiment shown in FIG. 4A in which the activation input sensor 118 is not required.

The provision of a boost electric power that coincides with a user drawing on the aerosol generating device 100 results in an increased temperature in the aerosol substrate 102 at a time when the user is inhaling the generated aerosol. The increased temperature results in a boost in the amount of aerosol generated to coincide with the user drawing on the aerosol generating device 100.

Inhalation electric power P2 may also be known as a first electric power level. Priming electric power P1 may also be known as a second electric power level. Boost electric power P3 may also be known as a third electric power level. First, second and third does not necessarily represent a temporal order of the provided electric power.

In one example, the power supplied to the electrodes 106 during delivery of the priming electric power is between 5 W to 10 W, more preferably between 7 W and 9 W. Providing a priming electric power in this range means that the aerosol substrate is heated without providing a substantial amount of aerosol (i.e. only a negligible amount of aerosol would be generated at these levels)

In one example, the power supplied to the electrodes 106 during delivery of the inhalation electric power is between 15 W to 25 W, more preferably between 18 W and 22 W. Providing an electric power at this range means that a satisfying amount of aerosol is generated, but the power delivery can be managed efficiently. That is to say that the aerosol generating device is not always providing power at this level

In one example, the power supplied to the electrodes 106 during delivery of the boost electric power is between 20 W to 30 W, more preferably between 23 W to 27 W. The boost power would deliver a relatively high level of aerosol, but is only provided for a relatively short period of time and so the device is working efficiently.

In one example, the proximity sensor 110 is only activated when the temperature sensor 122 records a priming temperature. In other words, the aerosol generating device 100 is preventing from providing an inhalation power P2 to the aerosol substrate 102 until the temperature sensor 122 has recorded a priming temperature. Similarly, the image sensor 116 may only be activated when the temperature sensor 122 records a priming temperature.

In one example, the priming temperature is between 100° C. to 150° C. That is to say that the priming electric power is configured to heat the aerosol substrate to a temperature of between 100° C. to 150° C., more preferably 120° C. to 130° C.

In one example, the inhalation electric power is configured to heat the aerosol substrate 102 to an inhalation temperature of between 200° C. and 300° C., more preferably between 230° C. and 280° C.

In one example, the inhalation electric power is configured to heat the aerosol to an inhalation temperature of between 180° C. and 220° C. and the boost electric power is configured to heat the aerosol substrate to a boost temperature of between 200° C. and 300° C., more preferably between 230° C. and 280° C.

In one example, the aerosol generating device 100 includes a haptic feedback device (not shown). The haptic feedback may be used to alert the user that the aerosol substrate 102 has reached the priming temperature and that the user may take an inhalation action, which will cause the provided electric power to increase to the inhalation electric power when the proximity sensor 110 detects that the user 200 is within the predetermined threshold. In some embodiments, as described above, the provided electric power will increase to the boost electric power when the inhalation action of the user has been detected.

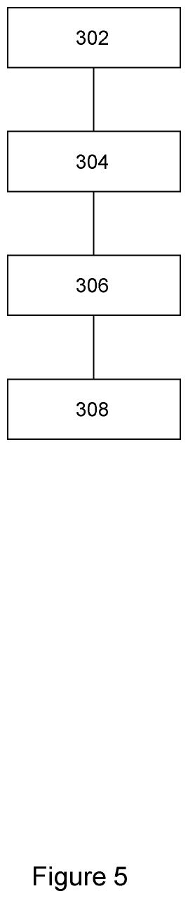

FIG. 5 shows a flow-chart of a method of operating an aerosol generating device 100. At step 302, the method includes the step of sensing, at a proximity sensor 110, a proximity to a user 200 in a first direction A.

At step 304, the method includes the step of comparing the sensed proximity with a predetermined threshold.

At step 306, the method includes the step of determining that the sensed proximity is less than the predetermined threshold.

As step 308, the method includes the step of increasing an electric power provided to at least two electrodes 106 of the aerosol generating device 100 to an inhalation electric power. The at least two electrodes are configured to electrically couple with an aerosol substrate 102 having one or more electrical conductors 126 therein.

Although preferred embodiments have been shown and described, it will be appreciated by those skilled in the art that various changes and modifications might be made without departing from the scope of the invention, as defined in the appended claims and as described above.

1. An aerosol generating device for receiving an aerosol substrate and providing electric power to the aerosol substrate, the aerosol generating device comprising:
at least two electrodes configured to electrically couple with the aerosol substrate to provide electric power to the aerosol substrate, in use;
a proximity sensor configured to sense proximity of a user in a first direction; and
a control unit configured to:
compare the sensed proximity with a predetermined threshold; and
increase the electric power provided to the aerosol substrate to an inhalation electric power when the sensed proximity is less than the predetermined threshold.

2. The aerosol generating device according to claim 1, wherein the aerosol generating device is configured to be activated in response to a user's action, and
wherein the aerosol generating device is configured to provide a priming electric power to the aerosol substrate in response to the user's action,
wherein the priming electric power is less than the inhalation electric power.

3. The aerosol generating device according to claim 2, further comprising a puff sensor configured to detect an inhalation action on the aerosol generating device by the user, wherein the user's action is the inhalation action.

4. The aerosol generating device according to claim 1, further comprising a puff sensor configured to detect an inhalation action on the aerosol generating device by the user,
wherein the control unit is configured to increase the provided electric power from the inhalation electric power to a boost electric power in response to an inhalation action being detected by the puff sensor.

5. The aerosol generating device according to claim 4, wherein the puff sensor is configured to detect an end of an inhalation action on the aerosol generating device by the user, and wherein the control unit is configured to reduce the provided electric power from the boost electric power to the inhalation electric power when the end of the inhalation action is detected by the puff sensor.

6. The aerosol generating device according to claim 1, wherein the provided power is increased to the inhalation electric power as a step change when the sensed proximity is less than the predetermined threshold.

7. The aerosol generating device according to claim 1, wherein the provided power is increased to the inhalation electric power as a gradual change as a function of the sensed proximity.

8. The aerosol generating device according to claim 1, further comprising one or more temperature sensors configured to directly or indirectly measure a temperature of the aerosol substrate,
wherein the proximity sensor is activated when the one or more temperature sensors detects a priming temperature above a first temperature threshold.

9. The aerosol generating device according to claim 2, wherein the control unit is configured to reduce the provided electric power from the inhalation electric power to the priming electric power when the determined distance increases above the predetermined threshold.

10. The aerosol generating device according to claim 2, wherein the priming electric power is configured to heat the aerosol substrate to a priming temperature of between 0° C. and 125° C. and the inhalation electric power is configured to heat the aerosol substrate to an inhalation temperature of between 230° C. and 280° C.

11. The aerosol generating device according to claim 1, further comprising a mouthpiece,
wherein the proximity sensor is arranged adjacent to the mouthpiece, and the first direction extends along a longitudinal axis defined by the mouthpiece.

12. The aerosol generating device according to claim 1, further comprising a mouthpiece comprising a planar portion, wherein the proximity sensor is arranged on the planar portion of the mouthpiece and the first direction extends in a direction substantially perpendicular to the planar portion.

13. The aerosol generating device according to claim 1, further comprising an image sensor configured to detect a mouth of the user,
wherein the first direction extends between the proximity sensor and the mouth of the user, in use.

14. An aerosol generating system comprising:
the aerosol generating device according to claim 1; and
an aerosol substrate having one or more electrical conductors provided therein,
wherein the at least two electrodes are configured to electrically couple with the one or more electrical conductors in the aerosol substrate.

15. A method of operating an aerosol generating device comprising:
sensing, at a proximity sensor, a proximity to a user in a first direction;
comparing the sensed proximity with a predetermined threshold;
determining that the sensed proximity is less than the predetermined threshold; and
increasing an electric power provided to at least two electrodes of the aerosol generating device to an inhalation electric power,
wherein the at least two electrodes are configured to electrically couple with an aerosol substrate having one or more electrical conductors therein.
